(19) United States
(12) Patent Application Publication
(10) Pub. No.: US 2015/0125844 A1
(43) Pub. Date: May 7, 2015

(54) SERVER AND METHOD FOR MANAGING LEARNING

(71) Applicant: Teracle, Inc., Seoul (KR)

(72) Inventors: In Je CHO, Seoul (KR); Hoon Je CHO, Seoul (KR)

(73) Assignee: Teracle, Inc., Seoul (KR)

(21) Appl. No.: 14/191,412

(22) Filed: Feb. 26, 2014

(30) Foreign Application Priority Data
Nov. 1, 2013 (KR) 10-2013-0132541

(51) Int. Cl. G09B 7/00

(52) U.S. Cl. CPC G09B 7/00
USPC 434/353; 434/322

(57) ABSTRACT

A server and method for managing learning is provided. A correct answer ratio is checked based on a real-time solving process and solving time of a question provided to a learner by using a terminal such as a computer or a portable terminal such as a smartphone to induce the learner to sincerely learn.

### RELATED APPLICATIONS

This application claims the priority of Korean Patent Application No. 10-2013-0132541, filed on Nov. 1, 2013, in the Korean Intellectual Property Office, the disclosure of which is incorporated herein in its entirety by reference.

### BACKGROUND

1. Field

One or more embodiments of the present invention relate to a server and method for managing learning, and more particularly, to a server and method for managing learning, by which a correct answer ratio is checked based on a real-time solving process and solving time of a question set to a learner by using a terminal such as a computer or a portable terminal such as a smartphone in order to induce the learner to sincerely learn.

2. Description of the Related Art

As the Internet and personal communication technologies have recently developed, learning methods using electronic tools, such as remote learning, video learning, or the like, have been widely used in the learning field. According to these learning methods, lectures are given and test papers are solved on-line, and learning is performed only in a fixed position by using an individual personal computer (PC). However, as use of apparatuses using wireless Internet has recently rapidly increased, online learning is possible by using a smartphone, a tablet PC, or the like while walking or moving.

This form of online learning enables a learner to access a server through the internet to access learning materials stored in the server in order to learn. Therefore, like an existing learning video tape, a student may unilaterally receive an audio-visual education. However, it is difficult to manage insincere attitudes of students that frequently occur in on-line learning.

Also, online learning is performed only by one-way audiovisual education, and thus it is impossible to check a solving process of a question that is directly solved by a student like a mathematical question or the like. Therefore, many learners mistakenly recognize wrong solving processes as correct processes if answers to questions are correct. Also, when the learners recognize that if convincing solving processes are wrong, the learners are not convinced of solving processes of all questions with which the learners are well-acquainted. In serious cases, the learners lose self-confidence and thus lose their desire to learn.

### CITED DOCUMENT

### Patent Document

(Patent Document 1) Korean Patent Publication No. 2011-0070625
(Patent Document 2) Korean Patent Publication No. 2006-0017932

### SUMMARY

One or more embodiments of the present invention include a server and method for managing learning, by which a correct answer ratio is checked based on a real-time solving process and/or solving time of a question set to a learner by using a terminal such as a computer or a portable terminal such as a smartphone.

One or more embodiments of the present invention include a server and method for managing learning, by which a real-time solving process and/or solving time of a question set to a learner by using a terminal such as a computer or a portable terminal such as a smartphone are checked regardless of a time or place to improve an interest in learning of the learner.

One or more embodiments of the present invention include a server and method for managing learning, by which a learner checks a correct answer ratio to a question solved by the learner in real time to improve a learning performance.

Additional aspects will be set forth in part in the description which follows and, in part, will be apparent from the description, or may be learned by practice of the presented embodiments.

According to one or more embodiments of the present invention, a method of managing learning, performed using a server, includes: providing a question to a learner terminal; receiving a solving process and a solving time of the question from the learner terminal in real time; calculating solving process accuracy, a correct answer ratio, and accuracy of each learner according to the solving time of the question in real time; and providing learning evaluation contents in real time according to a request of a manager terminal.

The method may further include: providing the learning evaluation contents in real time according to a request of the learner terminal.

The method may further include: providing the learning evaluation contents, except for the accuracy, in real time according to a request of the learner terminal.

The method may further include: providing the learning evaluation contents in at least one of text form and graphical form in real time according to a request of the learner terminal.

The providing of the learning evaluation contents may include: comparing the solving process and a stored answer keyword; and calculating the solving process accuracy according to the number of solving processes and answer keywords that match each other.

The method may further include: if the solving process accuracy is higher than or equal to a reference rate, processing an answer of the learner as a correct answer.

The providing of the learning evaluation contents may include: if the solving time exceeds a time limit provided to the learner terminal or a preset reference time, processing the answer of the learner as a wrong answer.

The providing of the learning evaluation contents may include: applying a first weight to the solving time and applying a second weight to the solving process accuracy to calculate the accuracy.

The providing of the learning evaluation contents may include: calculating a correct answer ratio according to the solving time and the solving process accuracy.

The method may further include: calculating a time-based correct answer ratio according to a rate of the solving time that exceeds a time limit provided to the learner terminal or a preset reference time; calculating the solving process accuracy according to the number of solving processes and stored answer keywords that match each other; and summing the time-based correct answer ratio and a solving process accuracy-based correct answer ratio to calculate a correct answer.

The method may further include: applying a first weight to the time-based correct answer ratio and applying a second weight to the solving process accuracy-based correct answer ratio to calculate the accuracy.

The method may further include: providing the learning evaluation contents in at least one of text form and graphical form in real time according to a request of the manager terminal.

According to one or more embodiments of the present invention, a server for managing learning, includes: a question providing module which provides a question to a learner terminal; a time checking module which checks a question solving time received from the learner terminal; a solving process checking module which calculates accuracy of a question solving process received from the learner terminal; a correct answer ratio calculating module which calculates a correct answer ratio according to the question solving time and the question solving process accuracy; and a learning evaluating module which analyzes the question solving time, the question solving process accuracy, and the correct answer ratio of a learner in real time and generates learning evaluation contents comprising accuracy of the learner.

The learning evaluating module may provide the learning evaluation contents in real time according to a request of the learner terminal or a manager terminal;

The learning evaluation module may provide the learner terminal or the manager terminal with the learning evaluation contents in at least one of text form and graphical form in real time.

The solving process checking module may compare the question solving process with a stored answer keyword and calculate the solving process accuracy according to the number of question solving processes and answer keywords that match each other.

If the question solving process accuracy is higher than or equal to a reference rate, the correct answer ratio calculating module may process an answer of the learner as a correct answer.

If the question solving time exceeds a time limit provided to the learner terminal or a preset reference time, the correct answer ratio calculating module may process the answer of the learner as a wrong answer.

The correct answer ratio calculating module may calculate a time-based correct answer ratio according to a rate of the question solving time that exceeds the time limit provided to the learner terminal or the preset reference time, calculate solving process accuracy according to the number of question solving processes and stored answer keywords that match each other to calculate the solving process accuracy-based correct answer ratio, and sum the time-based correct answer ratio and the solving process accuracy-based correct answer ratio to calculate a correct answer ratio.

The learning evaluating module may apply a first weight to the question solving time and apply a second weight to the question solving process accuracy to calculate the accuracy.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view illustrating a learning management system according to an embodiment of the present invention;

FIG. 2 is a schematic block diagram of a learner terminal that executes a learning management application, according to an embodiment of the present invention;

FIG. 3 is a flowchart illustrating a process of transmitting a question solving time and a question solving process through a learning management application and checking the transmission result in a learner terminal, according to an embodiment of the present invention;

FIGS. 4A through 4D are views illustrating a screen that displays a question solving process in a learner terminal, according to an embodiment of the present invention;

FIGS. 5A through 5D are views illustrating a screen for checking a question solving result in a learner terminal, according to an embodiment of the present invention;

FIG. 6 is a schematic block diagram illustrating a structure of a manager terminal that executes a learning management application, according to an embodiment of the present invention;

FIG. 7 is a flowchart illustrating a process of checking a question solving result of a learner through a learning management application in a manager terminal, according to an embodiment of the present invention;

FIGS. 8A through 8F are views illustrating a screen for checking a question solving result of a learner in a manager terminal, according to an embodiment of the present invention;

FIG. 9 is a schematic block diagram illustrating a structure of a learning management server according to an embodiment of the present invention; and

FIG. 10 is a flowchart illustrating a process of generating learning evaluation contents through a learning management server and providing the evaluation learning contents from the learning management server to a manager terminal and a learner terminal, according to an embodiment of the present invention.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

It will be understood that, although the terms, ‘first’, ‘second’, etc. may be used herein to describe various elements, these elements should not be limited by these terms. These terms are only used to distinguish one element from another.

The terminology used herein is for the purpose of describing particular embodiments only and is not intended to be limiting of example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

In the embodiments, “communication”, “communication network”, “Internet”, and “network” may have the same meaning. The terms mean a wired or wireless short-distance and wide area data transmitting and receiving network through which a user terminal, terminals of other users, and a download server transmit and receive data.

Hereinafter, the present invention will be described in detail by explaining embodiments of the invention with reference to the attached drawings. Like reference numerals in the drawings denote like elements.

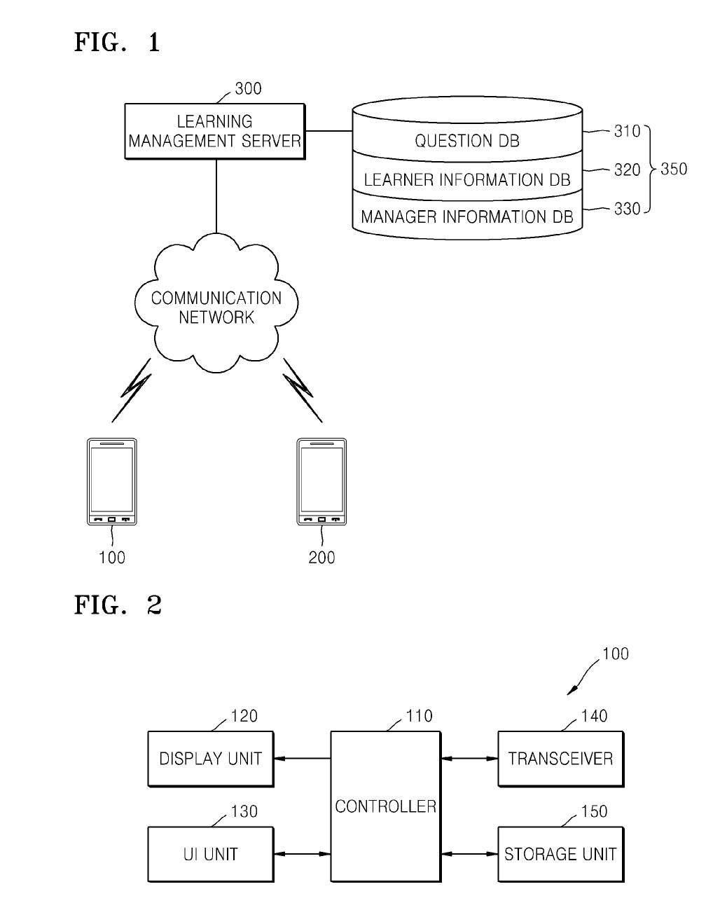

FIG. 1 is a view illustrating a learning management system according to an embodiment of the present invention.

Referring to FIG. 1, the learning management system includes a learner terminal 100, a manager terminal 200, and a learning management server 300. The learning management system may further include other elements besides the above-mentioned elements.

The learner terminal 100 and the manager terminal 200 are apparatuses that may access the learner management server 300 through a communication network such as the Internet. The learner terminal 100 and the manager terminal 200 may be mobile terminals such as notebook computers, hand-held devices, smartphones, taps, tablet personal computers (PCs), or the like, desktop computers, or arbitrary apparatuses that use these devices or are directly or indirectly connected to these devices.

The learner terminal 100 accesses the learning management server 300 to download and install a learning management application for solving a set question and checking a solving result in real time.

The learner terminal 100 executes the learning management application to access the learning management server 300, receives a pre-registered question from the learning management server 300, and displays the pre-registered question. Here, the question may include various types of questions. For example, if a learner is a high school student, the question may be questions of curriculum subjects such as Korean, English, mathematics, etc. Alternatively, the question may be a question that is used by designated education institutes to evaluate learners according to class units, school units, city units, province units, and nation units. The question may also be a subjective question, an objective question, a question requiring a solving process, or an essay question requiring opinions of an examinee. When the learner terminal 100 receives a question from the learning management server 300, the learner terminal 100 may receive and display a time limit taken for solving each question together.

The learner terminal 100 may record a solving process in an area based on the question received from the learning management server 300. Here, the solving process may indicate a series of mathematical equations for obtaining a correct answer if the question is a mathematical question. If the question is an essay question, the solving process may be a sentence or a paragraph including a series of words for obtaining a correct answer. Although the question is an objective question, the learner terminal 100 may record a selected correct answer along with the solving process.

The learner terminal 100 may completely write the solving process of the question and transmit an answer to the question and/or the solving process of the question to the learning management server 300. Here, the learner terminal 100 may also transmit a solving time of the question. Alternatively, the learner terminal 100 may transmit a result value indicating whether the question is solved within the time limit, to the learning management server 300.

The learning management server 300 may provide the learner terminal 100 with a result of whether a question solving time, a correct answer ratio, solving process accuracy and/or a time limit have been kept, according to a request of the learner terminal 100.

The manager terminal 200 accesses the learning management server 300 to download and install a learning management application that is to check a question solving result of a learner in real time.

The manager terminal 200 executes the learning management application to access the learning management server 300, receives a question solving result of a learner who enters for a test from the learning management server 300, and displays the question solving result. Here, the question solving result may be learning evaluation content indicating a result of whether a question solving time, a correct answer, question solving accuracy, accuracy and/or a time limit of the learner who takes the test are kept. The manager terminal 200 may check learning evaluation contents of each learner from the learning management server 300 to induce sincere learning of each learner or improve a learning performance of each learner.

The learning management server 300 is connected to the learner terminal 100 and the manager terminal 200 through the communication network.

The learning management server 300 may be realized as hardware of a computing device that users access to execute a program that generates learning contents or may be realized as software or circuits. A plurality of production programs may be operated in one learning management server 300, and one or more learning management servers 300 for operating the production programs may exist according to functions thereof.

At least some of elements constituting the learning management server 300 may be constituted as software including at least one or more of an operating system (OS), an application program module, and other program modules and may be physically stored in various types of well-known storage units.

Middleware of a database (DB) or servers that perform payment processing may be connected to the learning management server 300, but a description thereof will be omitted herein.

The learning management server 300 may download a question or a question solving time limit to the learner terminal 100, check a question solving time and question solving process accuracy, and calculate a correct answer ratio based on a result of whether an answer to the uploaded question, and a question solving process, a question solving time, and/or a time limit of the uploaded question are kept. Also, the learning management server 300 may calculate accuracy of the learner according to the question solving time, the question solving process accuracy, and/or the correct answer ratio.

The learning management server 300 may analyze the question solving time, the question solving process accuracy, the correct answer ratio, and/or the accuracy as learning evaluation contents and download the learning evaluation contents to the manager terminal 200 according to a request of the manager terminal 200.

The learning management server 300 may download the question solving time, question solving process accuracy, and/or the correct answer ratio, but not the accuracy, to the learner terminal 100 according to a request of the learner terminal 100.

FIG. 2 is a schematic block diagram illustrating a structure of the learner terminal 100 that executes a learning management application, according to an embodiment of the present invention.

Referring to FIG. 2, the learner terminal 100 includes a controller 110, a display unit 120, a user interface (UI) unit 130, a transceiver 140, and a storage unit 150.

The controller 110 controls an overall operation of the learner terminal 100 and, if a learning management application is executed, transmits certification information to the learning management server 300

If certification is permitted by the learning management server 300, the controller 110 receives a question that a learner is to solve and displays the question. Here, the controller 110 may selectively receive and display a solving time limit of the corresponding question.

The controller 110 transmits a question solving process and a question solving time written by a learner to the learning management server 300. Here, if the question is an objective question, the controller 100 transmits the question solving process and the question solving time written by the learner and a selected answer to the learning management server 300 in real time.

The display unit 120 displays a screen on which the learning management application is executed. The display unit 120 may display a question, a solving time limit and a solving process of the corresponding question, and/or a time counted for the solving process and may also display a question solving result of the learner in real time. The display unit 120 may include at least one of a liquid crystal display (LCD), an organic light-emitting diode (OLED), an electrophorestic display (EPD), a flexible display, and a 3-dimensional (3D) display. Two or more display units 120 may exist according to a configuration of the learner terminal.

The UI unit 130 provides an interface for a user to control an operation of the learner terminal 100. In particular, the UI unit 130 receives a control signal of the learner for recording the question solving process and an answer selection by using the learning management application.

The transceiver 140 transmits and receives data, in particular, transmits and receives data related to execution of the learning management application, to and from the learning management server 300.

The storage unit 150 stores the learning management application, a downloaded question, and a time limit of the corresponding question, or a selected answer. The storage unit 150 stores the question solving process and the question solving time of the learner or a selected answer. The storage unit 150 may include at least one type of storage medium of a flash memory type, a hard disk type, a multimedia card micro type, a card type of memory (for example, a secure digital (SD) or XD memory, or the like), a random access memory (RAM), and a read only memory (ROM).

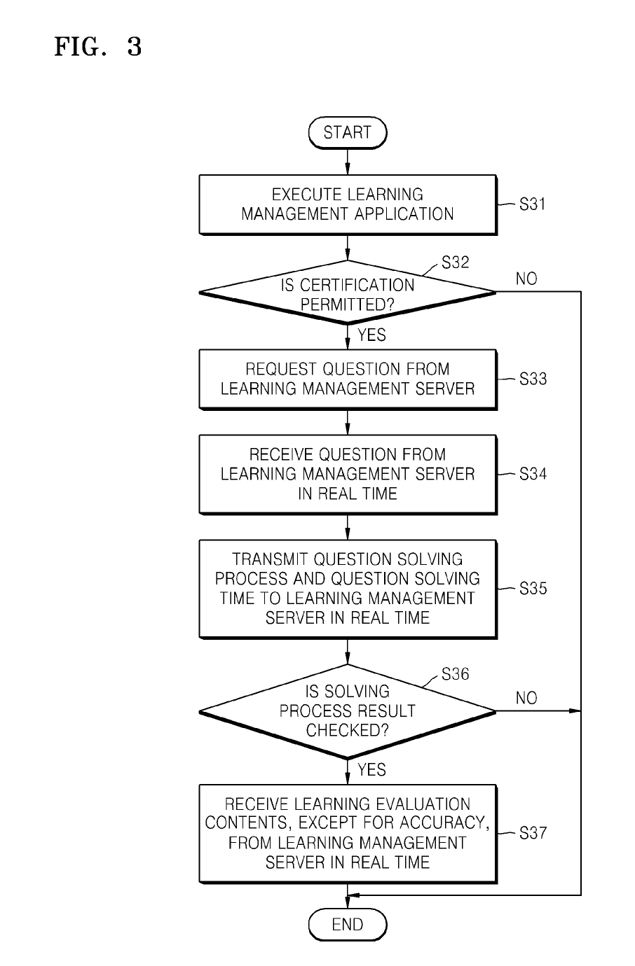

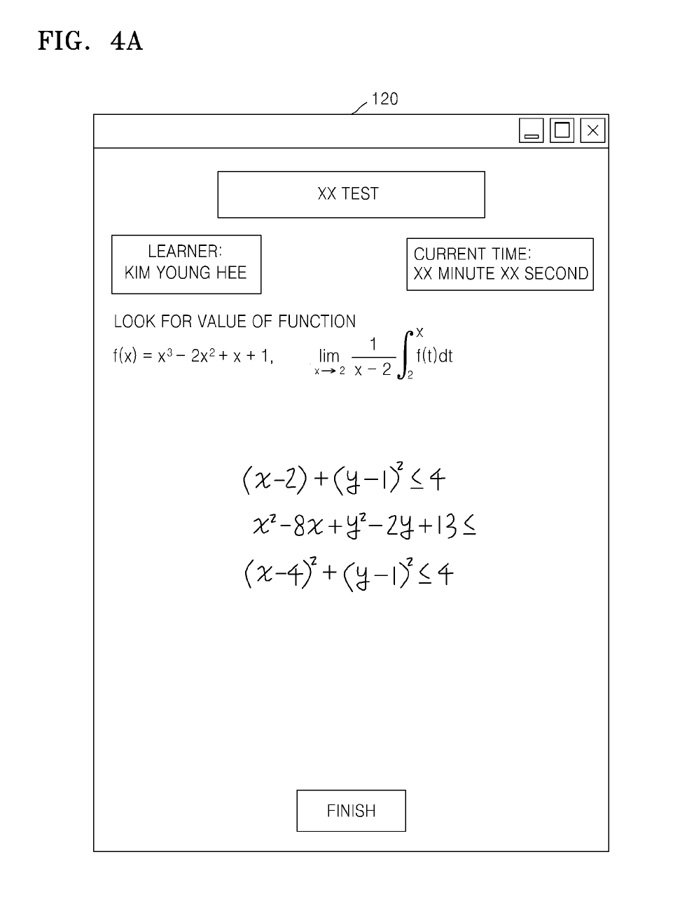

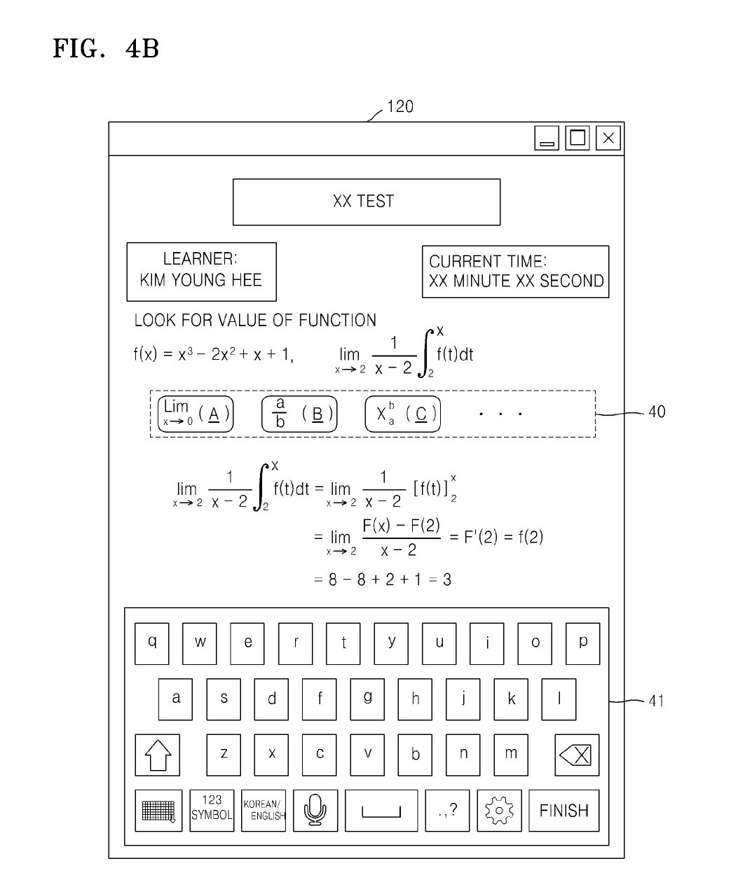

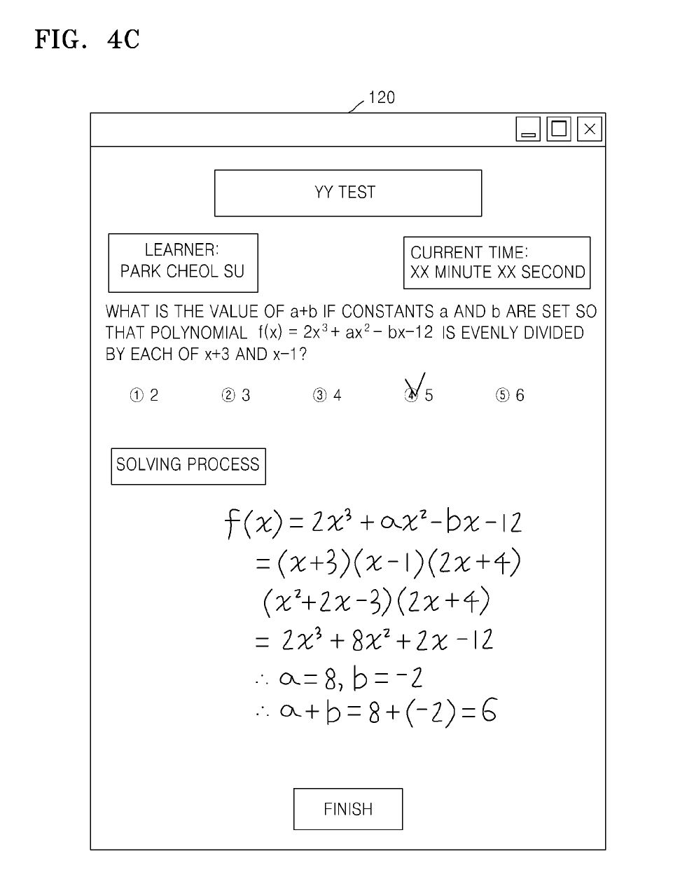

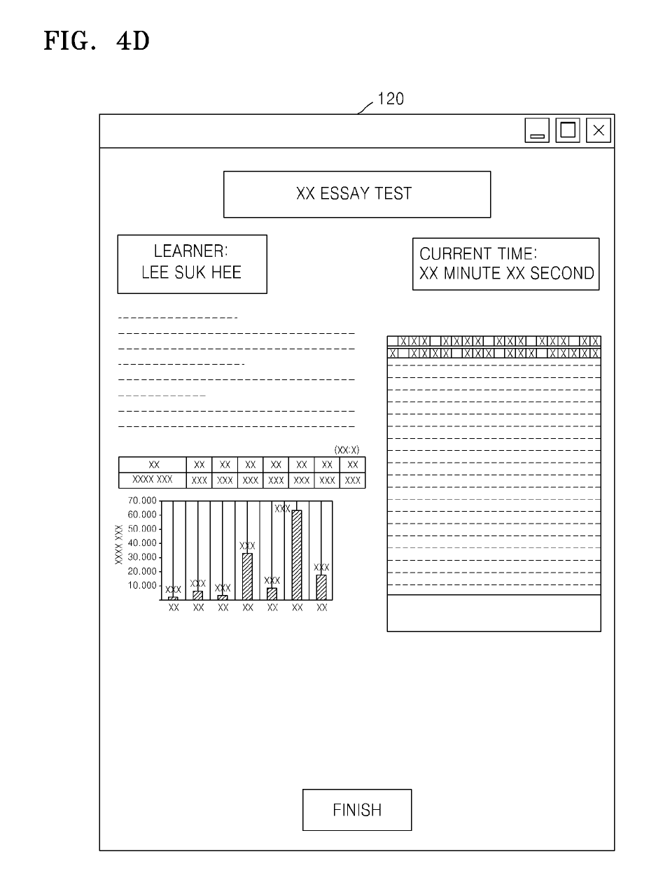

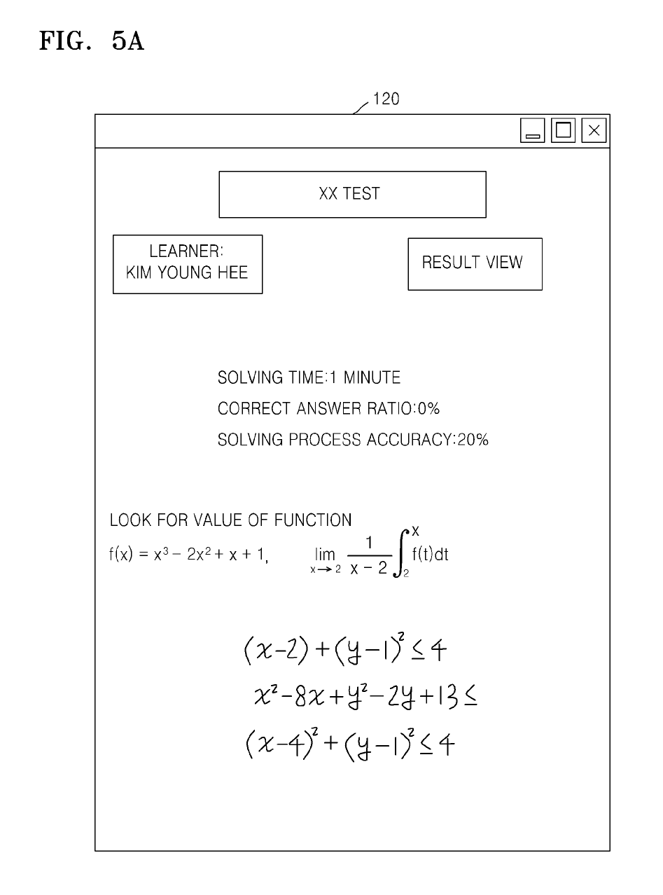

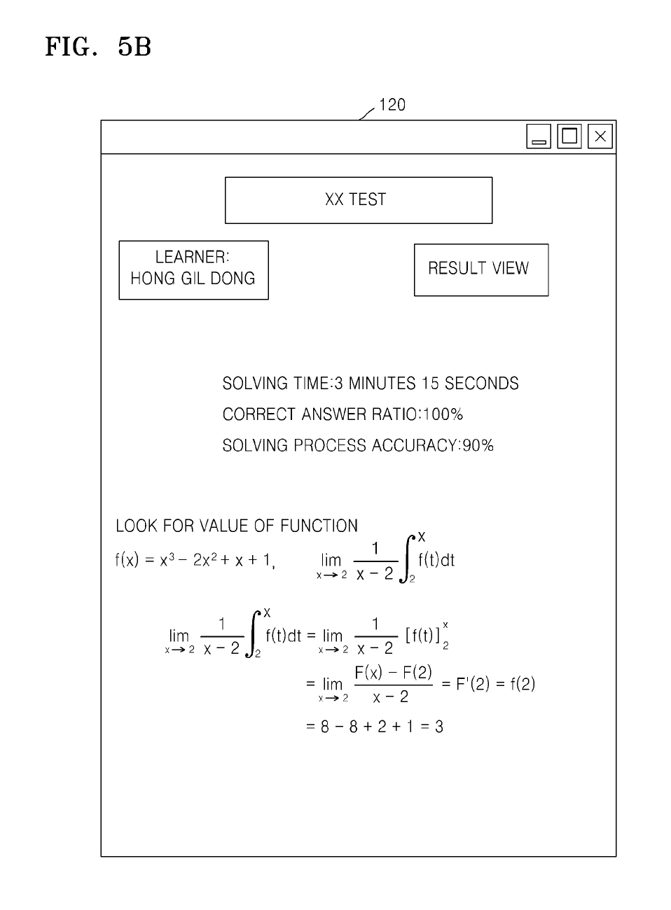

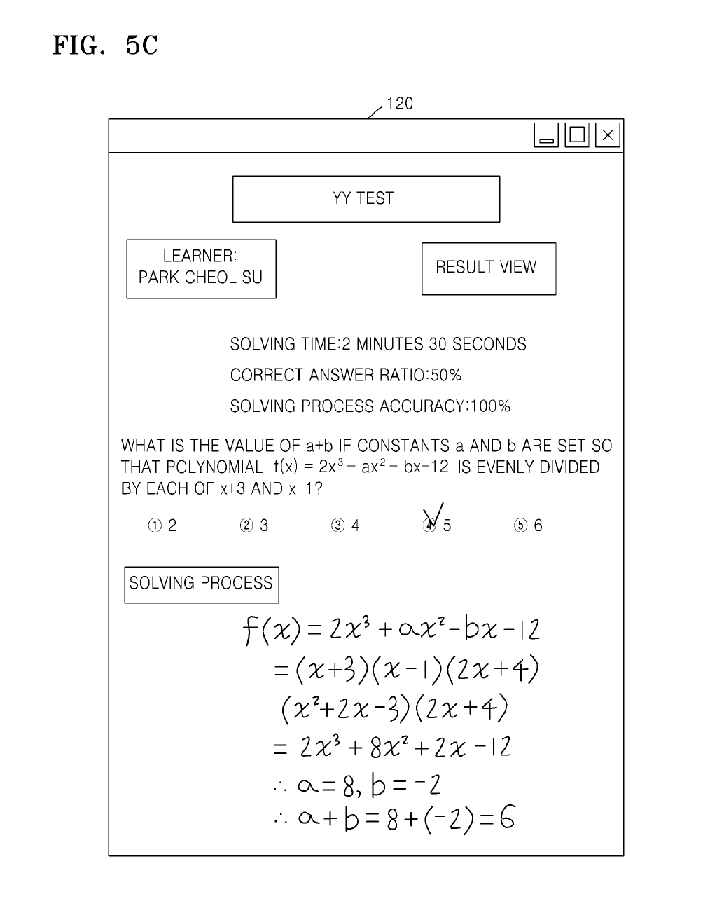

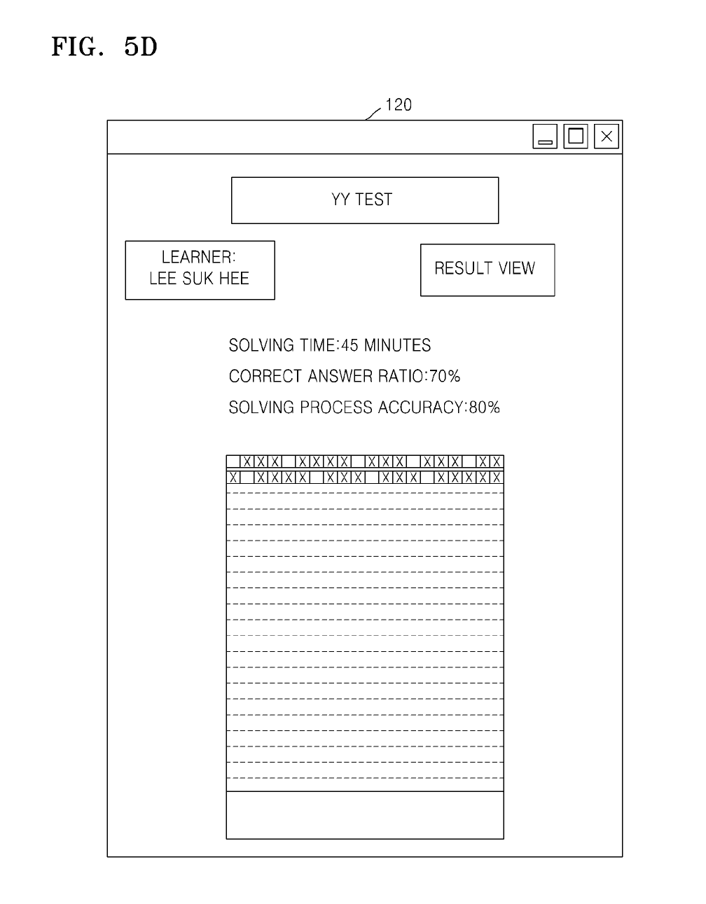

FIG. 3 is a flowchart illustrating a process of transmitting a question solving time and a question solving process through a learning management application and checking the transmission result in a learner terminal, according to an embodiment of the present invention. FIGS. 4A through 4D are views illustrating a screen that displays a question solving process in a learner terminal, according to an embodiment of the present invention. FIGS. 5A through 5D are views illustrating a screen for checking a question solving result in a learner terminal, according to an embodiment of the present invention.

Referring to FIGS. 3 through 5D, in operation S31, the controller 110 executes a learning management application. In operation S32, the controller 110 receives an ID and a password, which are registered when joining membership, from a learner and requests certification from the learning management server 300 by using the ID and the password. Here, if the learner does not pre-join membership, the controller 110 requests the learner to perform a membership joining process.

If the certification is permitted by the learning management server 300 in operation S32, the controller 110 requests a question from the learning management server 300 in operation S33. In operation S34, the controller 110 displays a question, which is to be solved and is transmitted from the learning management server 300, and a selectively transmitted time limit on the display unit 120 as shown in FIGS. 4A through 4D

In operation S35, the controller 110 transmits a question solving process and a question solving time written by the learner to the learning management server 300.

FIG. 4A illustrates a solving process of a subjective question provided to learner “Kim, young-hee”. As shown in FIG. 4A, a question solving process is written on the learner terminal 100 by using an input unit such as an electronic pen (not shown). If the question solving process is completely written, “finish button” is input, and the controller 110 transmits a question solving process and a question solving time written by the learner to the learning management server 300.

FIG. 4B illustrates a solving process of a question provided to learner “Hong, gil-dong”. As shown in FIG. 4B, a mathematical question 40 to be used for solving a question and a keyboard 41 are displayed together on the display unit 120. Therefore, a question solving process is written by using the mathematical equation 40 and the keyboard 41. If the question solving process is completely written, “finish button” is input, and the controller 110 transmits a question solving process and a question solving time written by the learner to the learning management server 300.

FIG. 4C illustrates a solving process of learner “Park, cheol-su” and a selected answer to the question. As shown in FIG. 4C, a question solving process is written, and an answer is selected on the learner terminal 100 by using an input unit such as an electronic pen (not shown) or a keyboard. If the question solving process is completely written, and the answer is completely selected, “finish button” is input, and the controller 110 transmits the question solving process and a question solving time written by the learner to the learning management server 300.

FIG. 4D illustrates an opinion of an essay question provided to learner “Lee, suk-hee”. As shown in FIG. 4D, the learner writes an opinion on the learner terminal 100 by using an input unit such as an electronic pen or a keyboard. If the opinion is completely written, “finish button” is input, and the controller 110 transmits a question solving process and a question solving time written by the learner to the learning management server 300.

In operation S36, the controller 110 receives a request signal for checking a solving process result from the learner. In operation S37, the controller 110 accesses the learning management server 300 to download the question solving result in real time and display the question solving result on the display unit 120.

FIG. 5A illustrates a question solving result downloaded from the learning management server 300 according to a request of learner “Kim, young-hee”. A question solving process written by the learner “Kim, young-hee”, a question solving time, a correct answer ratio, and solving process accuracy are illustrated in FIG. 5A.

FIG. 5B illustrates a question solving result downloaded from the learning management server 300 according to a request of learner “Hong, gil-dong”. A question solving process written by the learner “Hong, gil-dong”, a question solving time, a correct answer ratio, and solving process accuracy are illustrated in FIG. 5B.

FIG. 5C illustrates a question solving result downloaded from the learning management server 300 according to a request of learner “Park, cheol-su”. A question solving process written by the learner “Park, cheol-su”, a question solving time, a correct answer ratio, and solving process accuracy are illustrated in FIG. 5C.

FIG. 5D illustrates a question solving result downloaded from the learning management server 300 according to a request of learner “Lee, suk-hee”. A question solving process written by the learner “Lee, suk-hee”, a question solving time, a correct answer ratio, and solving process accuracy are illustrated in FIG. 5D.

FIGS. 5A through 5D illustrate question solving results in text form. However, a question solving time, a correct answer ratio, and a solving process may be displayed in graphical forms.

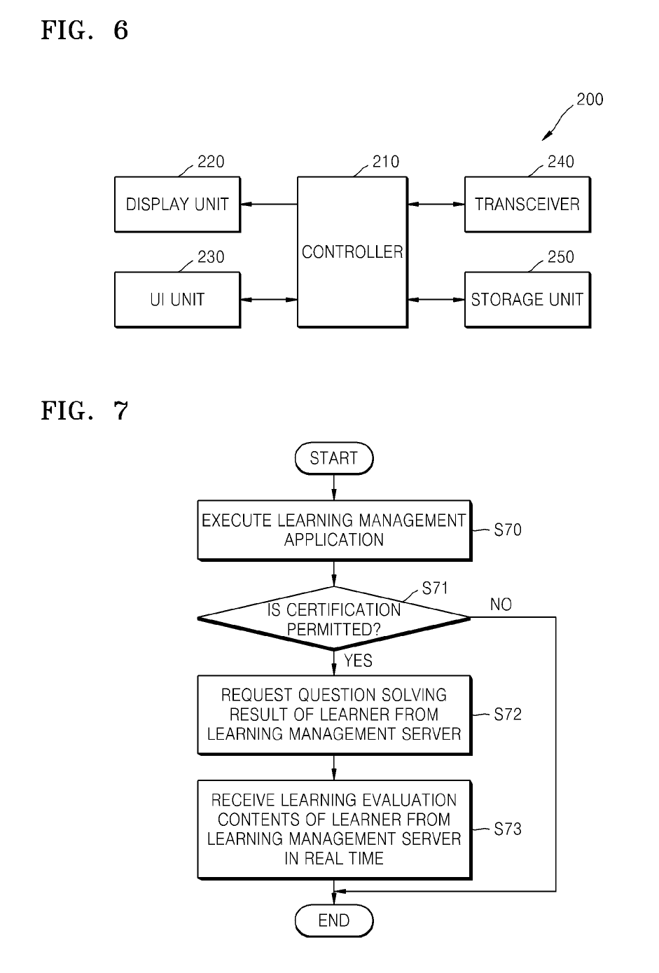

FIG. 6 is a schematic block diagram illustrating a structure of the manager terminal 200 that executes a learning management application, according to an embodiment of the present invention.

Referring to FIG. 6, the manager terminal 200 includes a controller 210, a display unit 220, a UI unit 230, a transceiver 240, and a storage unit 250.

The controller 210 controls an overall operation of the manager terminal 200 and, if the learning management application is executed, transmits certification information to the learning management server 300.

If certification is permitted by the learning management server 300, the controller 210 receives learning evaluation contents of each learner or all learners that are referred to by a manager and displays the learning evaluation contents.

The display unit 220 displays a screen on which the learning management application is executed. The display unit 220 may display a question solving time, a question solving process, question solving accuracy, a correct answer ratio, and/or accuracy of a learner in real time. The display unit 220 may include at least one of an LCD, an OLED, an EPD, a flexible display, and a 3D display. Two or more display units 220 may exist according to a configuration of the manager terminal 200.

The UI unit 230 provides an interface with a user to control an operation of the manager terminal 200. In particular, the UI unit 230 receives a control signal of the manager for searching for learning evaluation contents by using the learning management application and transmits the control signal to the controller 210.

The transceiver 240 transmits and receives data, in particular, transmits and receives data related to execution of the learning management application with the learning management server 300.

The storage unit 250 stores the learning management application and downloaded learning evaluation contents of the learner, i.e., a question solving time, a question solving process, question solving process accuracy, a correct answer ratio, and accuracy of the learner. The storage unit 250 may include at least one type of storage medium of a flash memory type, a hard disk type, a multimedia card micro type, a card type memory (for example, an SD or XD memory, or the like), a RAM, and a ROM.

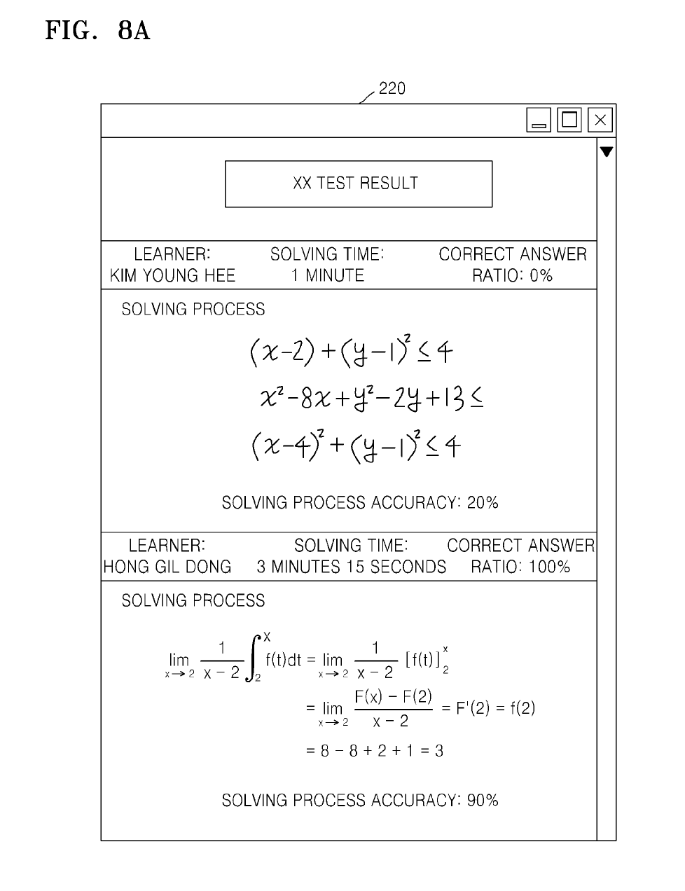

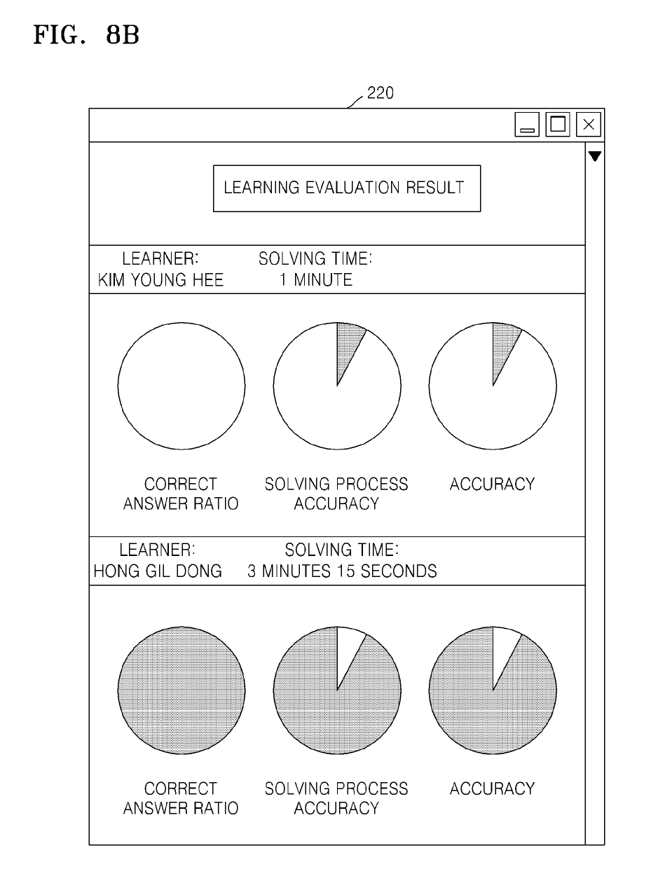

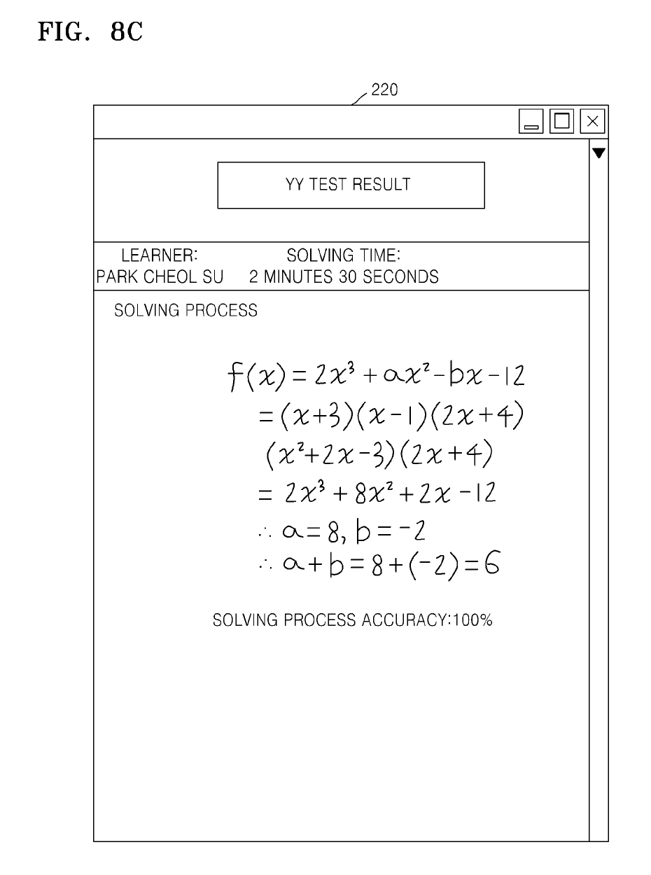

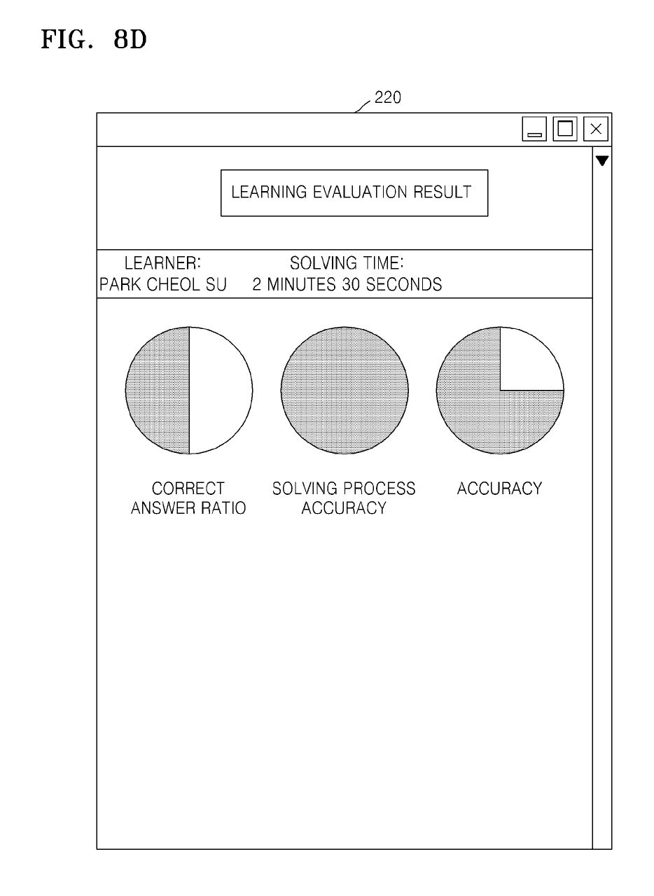

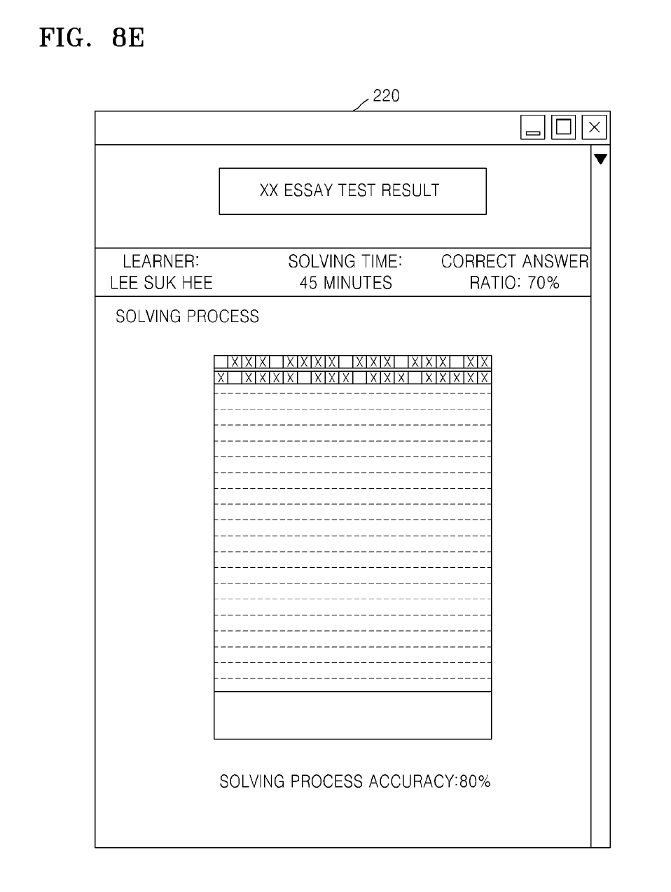

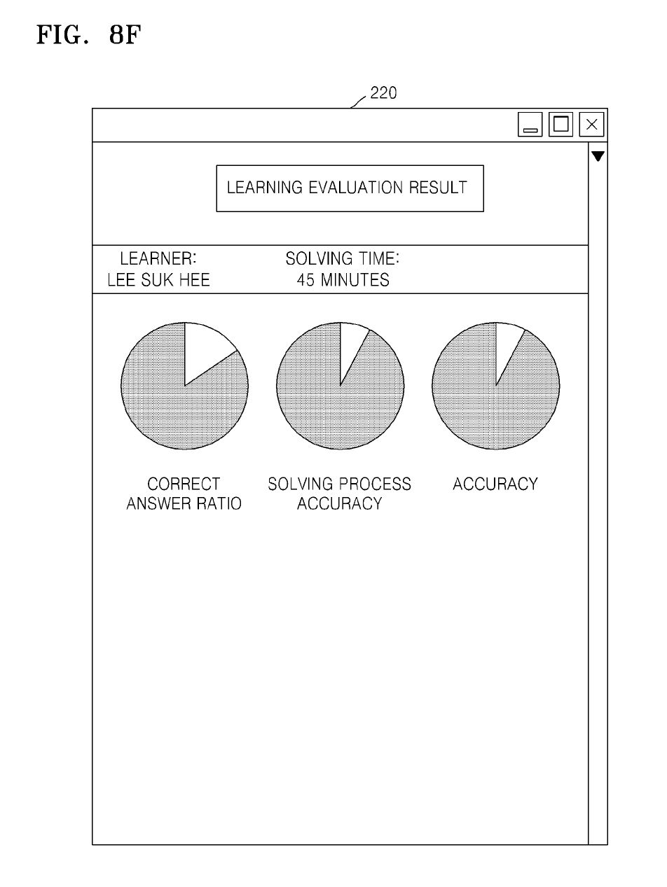

FIG. 7 is a flowchart illustrating a process of checking a question solving result of a learner through a learning management application in a manager terminal, according to an embodiment of the present invention. FIGS. 8A through 8F are views illustrating a screen for checking a question solving result of a learner in a manager terminal, according to an embodiment of the present invention.

Referring to FIGS. 7 through 8F, in operation S70, the controller 210 executes a learning management application. In operation S71, the controller 210 receives an ID and a password, which are registered when joining membership, from a manager and requests certification from the learning management server 300 by using the ID and the password. Here, if the manager does not pre-join membership, the controller performs a membership joining process.

If the certification is permitted by the learning management server 300 in operation S71, the controller 210 requests a question solving result of a learner from the learning management server 300 in operation S72. In operation S73, the learning management server 300 displays the question solving result of the learner on the display unit 220 as shown in FIGS. 8A through 8F.

FIG. 8A illustrates subjective question solving results of learners “Kim, young-hee” and “Hong, gil-dong” that are displayed in text form. A question solving process, a question solving time, question solving process accuracy, and a correct answer ratio of each learner are illustrated in FIG. 8A. FIG. 8B illustrates subjective question solving results of learners “Kim, young-hee” and “Hong, gil-dong” that are displayed in graphical form. A question solving time, question solving accuracy, a correct answer ratio, and accuracy are illustrated in graphical form in FIG. 8B.

FIG. 8C illustrates an objective question solving result of learner “Park, cheol-su” that is displayed in text form. A question solving process, a question solving time, question solving process accuracy, and a correct answer ratio of the learner are illustrated in FIG. 8C. Here, the question solving process is 100%, but a correct answer is wrongly selected, and thus the correct answer ratio is reduced. FIG. 8D illustrates a question solving result of learner “Park, cheol-su” that is displayed in a graphical form. A question solving time of the learner, question solving accuracy, a correct answer ratio, and accuracy are illustrated in graphical form in FIG. 8D.

FIG. 8E illustrates an essay question solving result of learner “Lee, suk-hee” that is displayed in text form. A question solving process, a question solving time, question solving process accuracy, and a correct answer ratio of the learner are illustrated in FIG. 8E. FIG. 8F illustrates an essay question solving result of learner “Park, cheol-su” that is displayed in graphical form. A question solving time of the learner, question solving process accuracy, a correct answer ratio, and accuracy are illustrated in graphical form in FIG. 8F.

The question solving process accuracy may be automatically calculated by a program stored in the learning management server 300 but is not limited thereto. Alternatively, the manager may check a question solving process of a learner and then input an evaluation result of accuracy of the question solving process.

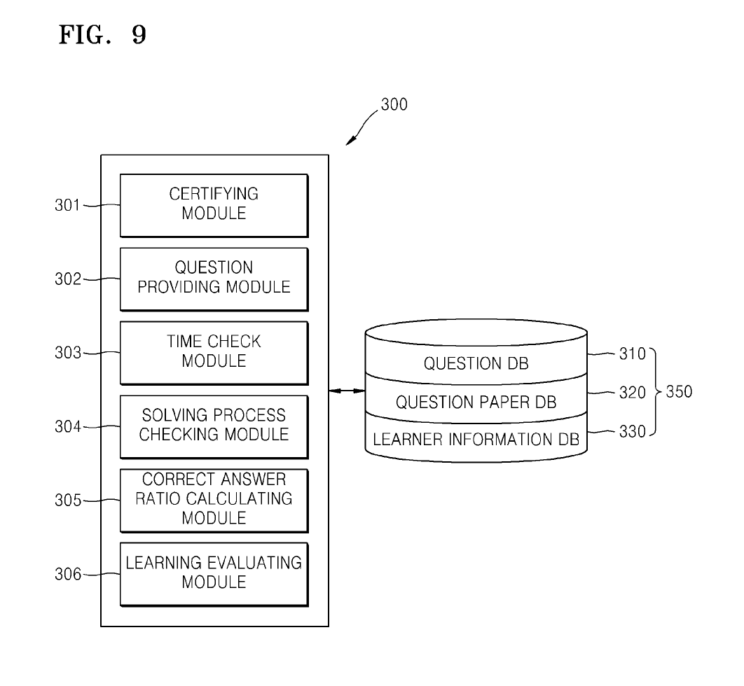

FIG. 9 is a schematic block diagram illustrating a structure of the learning management server 300, according to an embodiment of the present invention.

Referring to FIG. 9, the learning management server 300 includes a certifying module 301, a question providing module 302, a time checking module 303, a solving process checking module 304, a correct answer ratio calculating module 305, a learning evaluating module 306, and a database (DB) 350 including a question DB 310, a learner information DB 320, and a manager information DB 330.

The certifying module 301 performs certifications of a learner and a manager in real time based on information stored in the learner information DB 320 and the manager information DB 330.

The question providing module 302 provides the learner terminal 100 with a question stored in the question DB 310 and a solving time limit of the question in real time. Here, although not shown in the question DB 310, the question DB 310 may periodically receive and store a question and a solving time limit of the question from a question setting terminal (not shown). The question DB 310 stores information related to an answer to the question. The question providing module 302 may provide the manager terminal 200 with the question stored in the question DB 310 and the solving time limit of the question.

The time checking module 303 checks a question solving time transmitted from the learner terminal 100 in real time. Since the time checking module 303 is connected to the correct answer ratio calculating module 305, the correct answer ratio calculating module 305 processes an answer of a learner who exceeds a time limit, as a wrong answer according to a check result of the time checking module 303.

Alternatively, the correct answer ratio calculating module 305 may calculate a correct answer ratio based on a time limit exceeding rate checked by the time checking module 303. For example, if the learner exceeds a first time limit (for example, 10 seconds) according to a time check result of the time checking module 303, the correct answer ratio calculating module 305 may lower the correct answer ratio by 5%. If the learner exceeds a second time limit (for example, 30 seconds) according to the time check result of the time checking module 303, the correct answer ratio calculating module 305 may lower the correct answer ratio by 10%. In order to provide a time-based correct answer ratio according to a rate of exceeding a time limit as described above, a correct answer ratio may be lowered rather than processing an answer of a learner who solves a question in excess of a time limit as a wrong answer to induce a learning performance. Here, a time limit exceeding rate and a lowering range of a correct answer ratio may be flexibly adjusted, for example, may be adjusted by a manager.

The solving process checking module 304 checks the question solving process transmitted from the learner terminal 100 in real time. The solving process checking module 304 may compare the question solving process transmitted from the learner terminal 100 with an answer keyword stored in the question DB 310 and calculate solving process accuracy according to the number of question solving processes and answer keywords that match each other. For example, if there are 10 answer keywords of a question, and a solving process includes 10 answer keywords, solving process accuracy is 100%. The solving process accuracy is not acquired only by the solving process checking module 304 and may be calculated by an input of a manager as described above. Alternatively, a part of the solving process accuracy may be performed by the solving process checking module 304, and the other part of the solving process accuracy may be performed by an input of the manager.

Since the solving process checking module 304 is connected to the correct answer ratio calculating module 305, the correct answer ratio calculating module 305 may perform correct answer processing if the solving process accuracy checked by the solving process checking module 304 is higher than or equal to a reference rate, for example, is higher than or equal to 90%.

Alternatively, the correct answer ratio calculating module 305 may calculate a solving process accuracy-based correct answer ratio based on a solving process accuracy rate checked by the solving process checking module 304. For example, if the solving process accuracy rate is in a first range (for example, between 80% and 89%) according to a solving process accuracy check result of the solving process checking module 304, the correct answer ratio calculating module 305 may lower a correct answer by 5%. If the solving process accuracy rate is in a second range (for example, between 70% and 79%) according to the solving process accuracy check result of the solving process checking module 304, the correct answer ratio calculating module 305 may lower the correct answer ratio by 10%. In order to provide a time-based correct answer ratio based on a solving process accuracy rate, a correct answer ratio may be lowered rather than processing an answer of a learner who writes a less accurate solving process as a wrong answer to induce a learning performance. Here, a solving process accuracy rate and a lowering range of a correct answer ratio may be flexibly adjusted, for example, may be adjusted by the manager.

The correct answer ratio calculating module 305 calculates the correct answer ratio in real time by using various methods. For example, although solving process accuracy of a question of a learner who exceeds a time limit is higher than or equal to a reference rate, an answer of the learner may be processed as a wrong answer. Alternatively, although the learner writes a solving process within the time limit, and the solving process accuracy is lower than or equal to the reference rate, the answer of the learner may be processed as the wrong answer. Also, if the solving process accuracy is higher than or equal to the reference rate in the time limit, the answer of the learner may be processed as a correct answer. As described, a time-based correct answer ratio and a solving process accuracy-based correct answer ratio may be summed to calculate a correct answer ratio. Here, the correct answer ratio may be expressed as “correct and/or wrong” or as a percentage. However, the present invention is not limited thereto, and the correct answer ratio may be expressed by using various methods.

The learning evaluating module 306 analyzes the question solving time, the question solving process accuracy, and the correct answer ratio and generates learning evaluation contents including accuracy of the learner according to the analysis result. A process of calculating accuracy will now be described. A first weight may be applied to the question solving time, and a second weight may be applied to the question solving process accuracy to sum the question solving time and the question solving process accuracy in order to calculate accuracy. Here, the first and second weights may be flexibly adjusted, for example, may be adjusted by the manager. A manager who gives considerable thought to the question solving time may set the first weight to be higher than the second weight. A manager who gives considerable thought to the question solving process may set the second weight to be higher than the first weight.

The learning evaluating module 306 may provide the manager terminal 200 with the generated learning evaluation contents in text form and/or graphical form according to a request of the manager terminal 200. The learning evaluating module 306 may provide the learner terminal 100 with the learning evaluation contents, except for the accuracy, according to a request of the learner terminal 100.

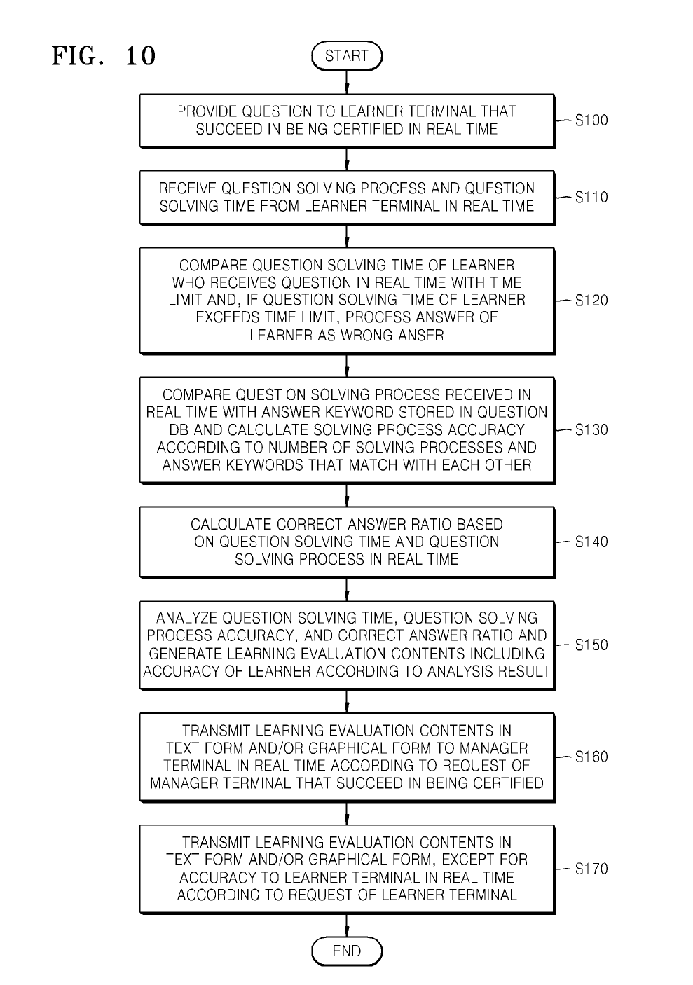

FIG. 10 is a flowchart illustrating a process of generating learning evaluation contents through a learning management server and providing the learning evaluation contents from the learning management server to a manager terminal and a learner terminal, according to an embodiment of the present invention.

Referring to FIG. 10, in operation S100, the learning management server 300 provides a question and a question solving time limit in real time to the learner terminal 100 that succeeds in being certified.

In operation S110, the learning management server 300 receives a question solving process and a question solving time from the learner terminal 100 in real time.

In operation S120, the learning management server 300 compares the question solving time of a learner received in real time with a time limit and, if the question solving time of the learner exceeds the time limit, processes an answer of the learner as a wrong answer. Here, according to another method, the learning management server 300 may calculate a time-based correct answer ratio based on a time limit exceeding rate. For example, if the question solving time of the learner exceeds a first time range (for example, 10 seconds) according to a time check result of the time checking module 305, the correct answer ratio calculating module 305 may lower a correct answer ratio by 5%. Here, a time limit exceeding rate and a lowering range of a correct answer ratio may be flexibly adjusted, for example, may be adjusted by a manager. The learning management server 300 may not provide a question solving time limit to the learner terminal 100. In this case, the learning management server 300 may have a preset reference time of question solving and process an answer of a learner who receives a question in real time as a wrong answer or calculate a time-based correct answer ratio according to whether a question solving time of the learner exceeds the preset reference time.

In operation S130, the learning management server 300 compares the question solving process received in real time with an answer keyword stored in a question DB and calculate solving process accuracy according to the number of question solving processes and answer keywords that match each other. For example, if there are 10 answer keywords of a question, and a solving process includes 10 answer keywords, solving process accuracy is 100%. Here, the learning management server 300 may calculate a solving process accuracy-based correct answer ratio based on a solving process accuracy rate. For example, if the solving process accuracy is in a first range (for example, between 80% and 89%) according to a solving process accuracy check result, the correct answer ratio calculating module 305 may lower the correct answer by 5%.

In operation S140, the learning management server 300 calculates a correct answer ratio in real time based on the question solving time and the question solving process. Here, the correct answer ratio may be calculated by using several methods. Therefore, although solving process accuracy of a question of a learner who exceeds a time limit is higher than or equal to a reference rate, an answer of the learner may be processed as a wrong answer. Alternatively, although a solving process is written within the time limit, and the solving process accuracy is lower than or equal to the reference rate, the answer of the learner may be processed as a wrong answer. Also, if the solving process accuracy is higher than or equal to the reference rate in the time limit, the answer of the learner may be processed as a correct answer. In addition, a time-based correct answer ratio and a solving process accuracy-based correct answer ratio may be summed to calculate a correct answer ratio as described above. Here, the correct answer ratio may be expressed as “correct and/or wrong” or as a percentage. However, the present invention is not limited thereto, and the correct answer ratio may be expressed by using various methods.

In operation S150, the learning management server 300 analyzes the question solving time, the question solving process accuracy, and the correct answer ratio and generates learning evaluation contents including accuracy according to the analysis result. A process of calculating the accuracy will now be described. A first weight may be applied to the question solving time, and a second weight may be applied to the question solving process accuracy to sum the question solving time and the question solving process accuracy in order to calculate the accuracy. Here, the first and second weights may be flexibly adjusted.

In operation S160, the learning management server 300 transmits the learning evaluation contents in text form and/or graphical form to the manager terminal 200 in real time according to a request of the manager terminal 200 that succeeds in being certified.

In operation S170, the learning management server 300 transmits the learning evaluation contents that are in text form and/or graphical form, except for the accuracy, to the learner terminal 100 in real time according to a request of the learner terminal 100.

As described above, according to the one or more of the above embodiments of the present invention, a correct answer ratio may be checked based on a real-time solving process and a solving time of a question set to a learner by using a terminal such as a computer or a portable terminal such as a smartphone to induce sincere learning of the learner. Also, real-time solving process and solving time of a question set to a learner by using a terminal such as a computer or a portable terminal such as a smartphone may be checked regardless of a time or place to improve an interest in learning of the learner.

The learner may check a correct answer ratio of the question solved by the learner in real time to improve a learning performance.

The present invention may also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A method of managing learning, performed using a server, the method comprising:
providing a question to a learner terminal;
receiving a solving process and a solving time of the question from the learner terminal in real time;
calculating solving process accuracy, a correct answer ratio, and accuracy of each learner according to the solving time of the question in real time; and
providing learning evaluation contents in real time according to a request of a manager terminal.

2. The method of claim 1, further comprising:
providing the learning evaluation contents in real time according to a request of the learner terminal.

3. The method of claim 2, further comprising:
providing the learning evaluation contents, except for the accuracy, in real time according to a request of the learner terminal.

4. The method of claim 2, further comprising:
providing the learning evaluation contents in at least one of text form and graphical form in real time according to a request of the learner terminal.

5. The method of claim 1, wherein the providing of the learning evaluation contents comprises:
comparing the solving process and a stored answer keyword; and
calculating the solving process accuracy according to the number of solving processes and answer keywords that match each other.

6. The method of claim 5, further comprising:
if the solving process accuracy is higher than or equal to a reference rate, processing an answer of the learner as a correct answer.

7. The method of claim 1, wherein the providing of the learning evaluation contents comprises: if the solving time exceeds a time limit provided to the learner terminal or a preset reference time, processing the answer of the learner as a wrong answer.

8. The method of claim 1, wherein the providing of the learning evaluation contents comprises: applying a first weight to the solving time and applying a second weight to the solving process accuracy to calculate the accuracy.

9. The method of claim 1, wherein the providing of the learning evaluation contents comprises: calculating a correct answer ratio according to the solving time and the solving process accuracy.

10. The method of claim 9, further comprising:
calculating a time-based correct answer ratio according to a rate of the solving time that exceeds a time limit provided to the learner terminal or a preset reference time;
calculating the solving process accuracy according to the number of solving processes and stored answer keywords that match each other; and
summing the time-based correct answer ratio and a solving process accuracy-based correct answer ratio to calculate a correct answer.

11. The method of claim 10, further comprising:
applying a first weight to the time-based correct answer ratio and applying a second weight to the solving process accuracy-based correct answer ratio to calculate the accuracy.

12. The method of claim 1, further comprising:
providing the learning evaluation contents in at least one of text form and graphical form in real time according to a request of the manager terminal.

13. A server for managing learning, the server comprising:
a question providing module which provides a question to a learner terminal;
a time checking module which checks a question solving time received from the learner terminal;
a solving process checking module which calculates accuracy of a question solving process received from the learner terminal;
a correct answer ratio calculating module which calculates a correct answer ratio according to the question solving time and the question solving process accuracy; and
a learning evaluating module which analyzes the question solving time, the question solving process accuracy, and the correct answer ratio of a learner in real time and generates learning evaluation contents comprising accuracy of the learner.

14. The server of claim 13, wherein the learning evaluating module provides the learning evaluation contents in real time according to a request of the learner terminal or a manager terminal;

15. The server of claim 14, wherein the learning evaluation module provides the learner terminal or the manager terminal with the learning evaluation contents in at least one of text form and graphical form in real time.

16. The server of claim 13, wherein the solving process checking module compares the question solving process with a stored answer keyword and calculates the solving process accuracy according to the number of question solving processes and answer keywords that match each other.

17. The server of claim 16, wherein if the question solving process accuracy is higher than or equal to a reference rate, the correct answer ratio calculating module processes an answer of the learner as a correct answer.

18. The server of claim 13, wherein if the question solving time exceeds a time limit provided to the learner terminal or a preset reference time, the correct answer ratio calculating module processes the answer of the learner as a wrong answer.

19. The server of claim 13, wherein the correct answer ratio calculating module calculates a time-based correct answer ratio according to a rate of the question solving time that exceeds the time limit provided to the learner terminal or the preset reference time, calculates solving process accuracy according to the number of question solving processes and stored answer keywords that match each other to calculate the solving process accuracy-based correct answer ratio, and sums the time-based correct answer ratio and the solving process accuracy-based correct answer ratio to calculate a correct answer ratio.

20. The server of claim 13, wherein the learning evaluating module applies a first weight to the question solving time and applies a second weight to the question solving process accuracy to calculate the accuracy.
